(19) United States
(12) Patent Application Publication
(10) Pub. No.: US 2017/0080541 A1
(43) Pub. Date: Mar. 23, 2017

(54) FIXTURE MEMBER FOR DETECTING A LOAD ACTING THEREON

(71) Applicant: Caterpillar Inc., Peoria, IL (US)

(72) Inventors: Balasubramanyam Appalla, Dunlap, IL (US); Justin C. Mach, Dunlap, IL (US); George K. Mathai, Peoria, IL (US); Nien L. Lee, Peoria, IL (US)

(73) Assignee: Caterpillar Inc., Peoria, IL (US)

(21) Appl. No.: 14/857,897

(22) Filed: Sep. 18, 2015

(51) Int. Cl. B23Q 17/00; G01L 1/22

(52) U.S. Cl. CPC B23Q 17/005; G01L 1/22; B33Y 10/00

(57) ABSTRACT

A fixture member in contact with a work piece to detect a load caused by the work piece is disclosed. The fixture member includes a first layer and a second layer defining a first thickness and a second thickness, respectively. The second layer is disposed on the first layer. The second layer is further in contact with the work piece. The fixture member also includes a sensing device disposed between the first layer and the second layer. The sensing device is configured to generate a signal indicative of the load caused by the work piece.

### TECHNICAL FIELD

The present disclosure relates to a fixture member for detecting a load acting thereon and a method of manufacturing the fixture member.

### BACKGROUND

During machining or other manufacturing operations on a work-piece or a work piece, it may be important for the work-piece or body to be securely engaged and positioned. Any deviation in positioning of the work-piece may affect quality of machining other manufacturing operation performed on the work-piece. In order to ensure an appropriate positioning or alignment of the work-piece, one or more fixture members may be provided on the manufacturing operation center for holding and supporting the work-piece. However, such fixture members may be inadequate in maintaining the work-piece securely engaged and positioned, and may further provide no feedback as to whether any particular fixture, or all fixtures are maintaining the work-piece in an appropriate and secure position or alignment.

WIPO Patent Publication Number 2008/142104 discloses a method for producing a model and a correspondingly prefabricated semi-finished product. In order to be able to produce models having complex built-in elements in a simple manner, a frame with the at least one built-in element is initially mounted onto the carrier plate so that it passes through the entire production process of the model.

### SUMMARY OF THE DISCLOSURE

In one aspect of the present disclosure, a fixture member in contact with a work piece for detecting a load caused by the work piece is provided. The fixture member includes a first layer and a second layer defining a first thickness and a second thickness, respectively. The second layer is disposed on the first layer, and is in contact with the work piece. The fixture member further includes a sensing device disposed between the first layer and the second layer. The sensing device is configured to generate a signal indicative of the load caused by the work piece.

In another aspect of the present disclosure, a system is provided. The system includes a work piece causing a load and a fixture member. The fixture member includes a first layer and a second layer defining a first thickness and a second thickness, respectively. The second layer is disposed on the first layer, and is in contact with the work piece. The fixture member further includes a sensing device disposed between the first layer and the second layer. The sensing device is configured to generate a signal indicative of the load caused by the work piece. The system further includes a controller in communication with the sensing device. The controller is configured to determine the load based on the signal received from the sensing device.

In yet another aspect of the present disclosure, a method of manufacturing a fixture member is provided. The fixture member is configured to detect a load acting thereon. The method includes generating an output layer based on a digital model of the fixture member. Further, the output layer is communicated to a 3D printing machine. The method further includes forming a first layer having a first thickness based at least in part on the output layer. A sensing device is further disposed on the first layer. The sensing device generates a signal indicative of the load acting on the fixture member. The method further includes forming a second layer having a second thickness based at least in part on the output layer. The second layer is disposed on the first layer.

Other features and aspects of this disclosure will be apparent from the following description and the accompanying drawings.

### BRIEF DESCRIPTION OF THE DRAWINGS

FIG. 1 is a partial perspective view of an exemplary manufacturing center employing a system for detecting a load caused by a work piece positioned on the manufacturing center, according to an embodiment of the present disclosure;

FIG. 2 is an exploded view of a fixture member of the system, according to an embodiment of the present disclosure;

FIG. 3 shows a method of assembling the fixture member, according to an embodiment of the present disclosure; and

FIG. 4 is a flowchart of a method of manufacturing the fixture member, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

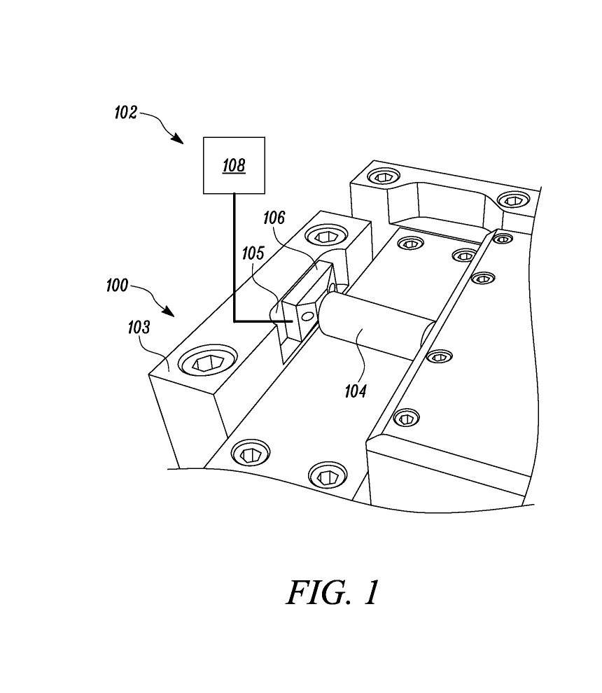

FIG. 1 illustrates a partial perspective view of an exemplary manufacturing center 100. The manufacturing center 100 may be used in various manufacturing sites to support one or more components thereon and perform various manufacturing operations, such as milling, grinding, boring, turning, welding, planning and the like on the one or more components. In an example, the manufacturing center 100 may include a milling machine, a lathe, a drill press, a surface grinding machine and a turning machine. The manufacturing center 100 employs a system 102, according to an embodiment of the present disclosure, for determining a load caused by the one or more components during mounting thereof on a base 103 of the manufacturing center 100 and/or during the manufacturing operation on the one or more components. As shown in FIG. 1, the component, hereinafter referred as ‘the work piece 104’, may be positioned on the base 103 of the manufacturing center 100 for illustration. The work piece 104 may be positioned on the base 103 of the manufacturing center 100 for performing one or more of the manufacturing operations thereon. The work piece 104 may be an unfinished or semi-finished component that may be required to be machined to proceed for further manufacturing process or implementing in a final product. It may be contemplated that the work piece 104 may be any component known in the art that may require one or more of the manufacturing operations.

The manufacturing operations may include, but are not limited to single point machining operations, multiple point machining operations, and abrasive machining operations. For performing such manufacturing operations, the work piece 104 may be positioned on or processed with machines that include, but are not limited to milling machines, lathe, drill presses, surface grinding machines, turning machines, and cylindrical grinding machines.

The system 102 includes the work piece 104 and a fixture member 106 disposed on the base 103 of the manufacturing center 100. The fixture member 106 is configured to detect the load caused by the work piece 104 positioned on the manufacturing center 100. The fixture member 106 is disposed within a slot 105 defined in the base 103. In one embodiment, the fixture member 106 may be coupled to the base 103 by one or more fastening members (not shown). In various embodiments, the fixture member 106 may be coupled to the base 103 by any fastening method known in the art. It may also be contemplated that the fixture member 106 may be disposed at any location in the base 103 to detect the load caused by the work piece 104. The fixture member 106 may be configured to support the work piece 104 in the manufacturing center 100. In one embodiment, the fixture member 106 may be mounted on the manufacturing center 100 in such a manner that the fixture member 106 may contact with the work piece 104 when the work piece 104 is positioned on the manufacturing center 100. As shown in the FIG. 1, the work piece 104 is disposed between two adjacent bases 103. One end of the work piece 104 is in contact with the fixture member 106 and another end of the work piece 104 is supported against another base 103. It may be contemplated that the position of the work piece 104 shown in FIG. 1 is exemplary, and the work piece 104 may be disposed in the manufacturing center 100 at any position. Further, the fixture member 106 may be disposed at any location in the base 103 to contact with the work piece 104 such that the fixture member 106 may detect the load caused by the work piece 104.

The fixture member 106 is configured to generate a signal indicative of the detected load. The system 102 further includes a controller 108 configured to be in communication with the fixture member 106 to determine the load caused by the work piece 104 on the fixture member 106. The controller 108 may include an operator interface (not shown) for an operator to enter input data and retrieve output data from the controller 108. The operator interface may include a display, control buttons and one or more input and output ports. As shown in FIG. 1, the controller 108 is located on a floor adjacent to the manufacturing center 100. However, it may be contemplated that the controller 108 may be disposed on the manufacturing center 100. In one embodiment, the controller 108 may be in communication with an external power device (not shown) for receiving an electric power therefrom. In another embodiment, an electric power device may be integrally formed with the controller 108.

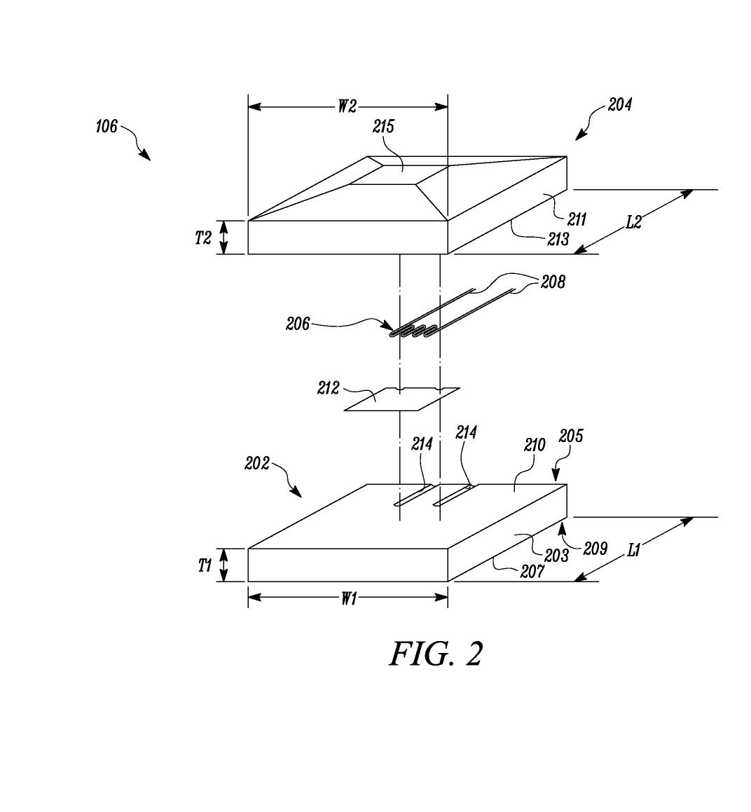

FIG. 2 illustrates an exploded view of the fixture member 106, according to an embodiment of the present disclosure. The fixture member 106 includes a first layer 202 defining a first thickness ‘T1’. The first layer 202 may have a first length ‘L1’, a first width ‘W1’ and a plurality of side surfaces 203 defined along the first length ‘L1’ and the first width ‘W1’. The first length ‘L1’ and the first width ‘W1’ may be smaller than or equal to a length and a width, respectively, of the slot 105 defined in the base 103. In another embodiment, the first length ‘L1’ and the first width ‘W1’ may be equal. The first layer 202 further includes a surface 210 defined on a top end 205 and a bottom surface 207 defined on a bottom end 209 thereof. The bottom surface 207 of the first layer 202 may be configured to contact with a corresponding surface of the slot 105 or any surface in the base 103. The first layer 202 further includes a pair of channels 214 extends laterally on the surface 210 adjacent to one of the side surfaces 203 thereof. The pair of channels 214 further extends inwardly from the side surface 203 of the first layer 202. Alternatively, the first layer 202 may include one channel 214 on the surface 210. In an example, the first thickness ‘T1’ may be 0.2 inches. It may be contemplated that the first thickness ‘T1’ may vary based on various parameters including, but not limited to, a size of the slot 105 and a type of material of the first layer 202.

The fixture member 106 further includes a second layer 204 defining a second thickness ‘T2’. The second layer 204 may have a second length ‘L2’, a second width ‘W2’ and a plurality of sided surfaces 203 defined along the second length ‘L2’ and the second width ‘W2’. The second length ‘L2’ and the second width ‘W2’ may be equal to the first length ‘L1’ and the first width ‘W2’, respectively, of the first layer 202. In other embodiments, the second length ‘L2’ and the second width ‘W2’ may be smaller or greater than the first length ‘L1’ and the first width ‘W2’, respectively, of the first layer 202. In yet another embodiment, the second length ‘L2’ and the second width ‘W2’ may be equal. The second layer 204 further includes a first surface 213 and a second surface 215 distal to the first surface 213. The first surface 213 is configured to abut the surface 210 of the first layer 202 and the second surface 215 is configured to contact with the work piece 104. The second thickness ‘T2’ of the second layer 204 is defined between the first surface 213 and the second surface 215 thereof. In an example, the second thickness ‘T2’ may be 0.6 inches. Therefore, an overall height of the fixture member 106 may become 0.8 inches, i.e., the sum of the first thickness ‘T1’ and the second thickness ‘T2’. In such an example, an overall length and an overall width of the fixture member 106 may be 2 inches and 1.5 inches, respectively. Thus, the fixture member 106 including the first layer 202 and the second layer 204 may be disposed on the manufacturing center 100, as shown in FIG. 1, in such a manner that while being positioned on the manufacturing center 100, the work piece 104 may contact with the second surface 215 of the second layer 204 of the fixture member 106.

The fixture member 106 further includes a sensing device 206 that is disposed between the first layer 202 and the second layer 204. The sensing device 206 is configured to generate a signal indicative of the load caused by the work piece 104 on the fixture member 106. The sensing device 206 includes an electric lead 208 configured to communicate with the controller 108. The electric lead 208 is received through the pair of channels 214 defined on the surface 210 of the first layer 202. The signal generated by the sensing device 206 may be communicated to the controller 108 through the electric lead 208. The controller 108 may determine the load caused by the work piece 104 based on the signal received from the sensing device 206. In one embodiment, the sensing device 206 is a strain gauge. As shown in FIG. 2, the strain gauge includes a strain sensing pattern having multiple turns of current conducting wire. The strain sensing pattern is further coupled with the electric lead 208. The controller 108 may communicate with the strain gauge to supply required electric current to the strain sensing pattern. The load of the work piece 104 may cause a strain on the strain sensing pattern, which in turn causes a change in resistance to a flow of current through the current conducting wires. The change in resistance may be communicated with the controller 108 to determine the load caused by the work piece 104 on the fixture member 106. The strain sensing pattern may experience a strain based on the load applied on the second layer 204.

In another embodiment, the sensing device 206 may be a load cell. The load cell may generate a signal indicative of the load caused by the work piece 104 on the second layer 204 of the fixture member 106. The load cell may convert a load into a measurable electrical output. Various types of load cells, such as hydraulic load cells and pneumatic load cells may be adapted to dispose between the first layer 202 and the second layer 204. However, in various embodiments, the sensing device 206 may include any other load sensing device known in the art. The sensing device 206 may be selected based on various factors, such as a type of machine operation, a maximum amount of load that may be caused by the work piece 104, method of mounting the fixture member 106 in the manufacturing center 100 and environmental conditions, such as surrounding temperature.

The fixture member 106 further includes an insulation member 212 disposed on the surface 210. The insulation member 212 is configured to enclose the sensing device 206. The surface 210 of the first layer 202 may be configured to receive the insulation member 212 thereon.

In the illustrated embodiment, the first layer 202 and the second layer 204 of the fixture member 106 is manufactured using a 3D printing process. The fixture member 106 may be manufactured in any shape and size via the 3D printing process. Dimensional characteristics of the fixture member 106 may vary based on various parameters including, but not limited to, a size, a shape and a weight of the work piece 104 to be machined, a type of the manufacturing operation to be performed on the work piece 104, a type of the manufacturing center 100, and the environmental factors, such as surrounding temperature.

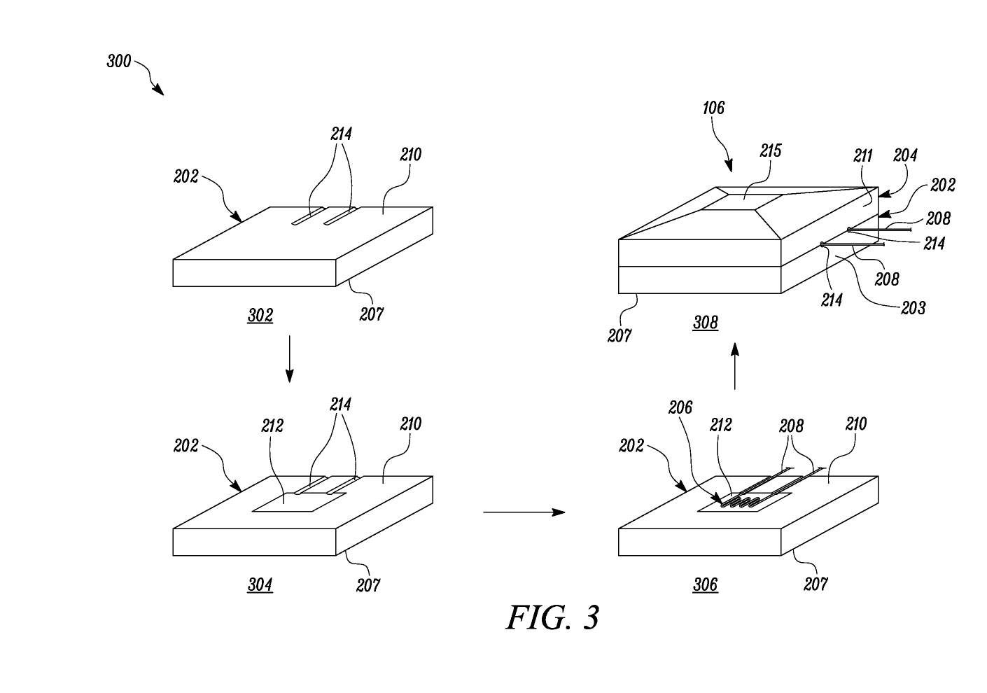

FIG. 3 illustrates a method 300 of assembling the fixture member 106, according to an embodiment of the present disclosure. At step 302, the first layer 202 having the channel 214 defined on the surface 210 may be located on a floor (not shown). The channel 214 is provided for receiving the electric lead 208 of the sensing device 206 therethrough such that the surface 210 of the first layer 202 may abut the first surface 213 of the second layer 204 in an assembled condition of the fixture member 106. At step 304, the method 300 includes disposing the insulation member 212 on the surface 210 of the first layer 202. The insulation member 212 may be disposed around a center of the surface 210 in such a manner that the insulation member may enclose the sensing device 206. In one example, the insulation member 212 may be engraved on the surface 210. In another example, the insulation member 212 may be attached on the surface 210 using an adhesive. In various embodiments, the insulation member may be disposed on the surface 210 of the first layer 202 using various attachment method known in the art.

At step 306, the method 300 includes disposing the sensing device 206 on the insulation member 212. The sensing device 206 may be positioned and aligned on the insulation layer 212 based on a predefined location of the sensing device 206 within the fixture member 106. The sensing device 206 may be disposed in such a manner that the sensing device 206 may stay in contact with the insulation member 212. The electric lead 208 of the sensing device 206 is further positioned within the pair of channels 214. The electric lead 208 further extends above the side surface 203 of the first layer 202. A portion of the electric lead 208 extending above the side surface 203 of the first layer 202 may be coupled with the controller 108 such that the load detected by the sensing device 206 may be communicated to the controller 108 through the electric lead 208.

At step 308, the method 300 includes disposing the second layer 204 on the first layer 202. The first surface 213 of the second layer 204 contacts with the surface 210 of the first layer 202. The second layer 204 may be further positioned on the first layer 202 to align the side surfaces 211 of the second layer 204 with the side surfaces 203 of the first layer 202. Thus, the first layer 202, the second layer 204 and the sensing device 206 are assembled together to form the fixture member 106 of the present disclosure to mount on the manufacturing center 100 for detecting the load acting thereon.

In one embodiment, the second layer 204 may be welded to the first layer 202. In one example, the surface 210 of the first layer 202 may be melted and subsequently, the second layer 204 may be welded to the first layer 202. In another example, a filler material may be added along a joint defined by the first layer 202 and the second layer 204. The filter material may cause bonding of the first layer 202 and the second layer 204 as the filler material cools down.

In another embodiment, the second layer 204 may be fastened to the first layer 202. In one example, the second layer 204 may include one or more through holes and the first layer 202 may include one or more blind holes corresponding to the one or more through holes. Thus, the second layer 204 may be fastened to the first layer 202 using fasteners including, but not limited to, bolts, screws and rivets. In another example, the fasteners may be integrally formed with at least one of the first and second layers 202, 204.

In yet another embodiment, the second layer 204 may be attached to the first layer 202 using an adhesive. In one example, the adhesive may be deposited on the surface 210 of the first layer 202 and the first surface 213 of the second layer 204 may be disposed on the surface 210 such that the first layer 202 and the second layer 204 may be attached together. The adhesive may include, but not limited to, anaerobics adhesives, cyanoacrylates, plastisols, rubber adhesives, polyurethanes, epoxies, and pressure sensitive adhesives.

### INDUSTRIAL APPLICABILITY

The present disclosure relates to the fixture member 106 for detecting the load caused by the work piece 104 and a method 400 of manufacturing the fixture member 106. The fixture member 106 may be positioned on any machine, such as the manufacturing center 100 for detecting the load caused by the work piece 104 positioned on the manufacturing center 100. Thus the work piece 104 is appropriately positioned on the manufacturing center 100 for performing manufacturing operations on the work piece 104 with desired quality.

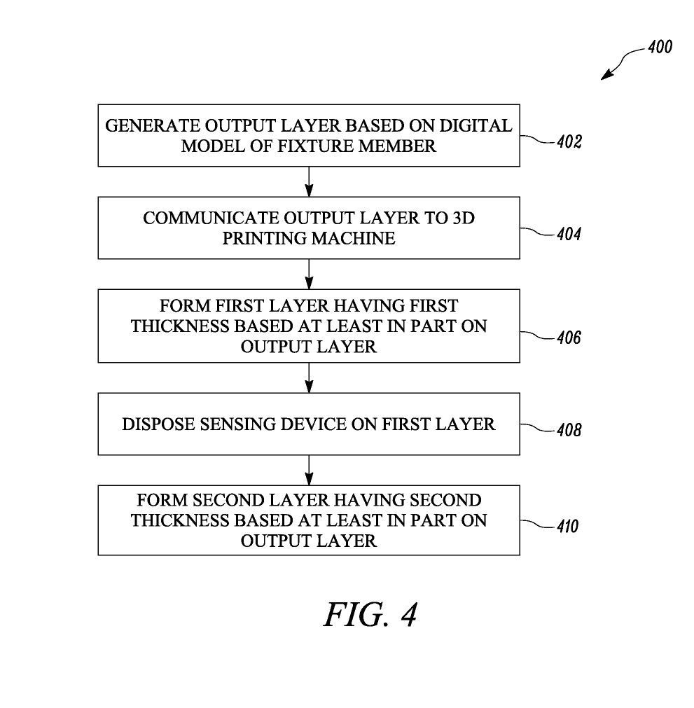

FIG. 4 illustrates a flow chart of the method 400 of manufacturing the fixture member 106, according to an embodiment of the present disclosure. In the illustrated embodiment, the fixture member 106 may be manufactured using the 3D printing process. 3D printing process, also referred to as additive manufacturing, is a process of forming a three dimensional object based on a digital file of the three dimensional object. With the 3D printing process, the fixture member 106 is manufactured by laying down successive layers of material until a desired size of the fixture member 106 is obtained.

At step 402, the method 400 includes generating an output layer based on a digital model of the fixture member 106 to be manufactured. In an example, the digital model or a virtual design of the fixture member 106 may be made in a Computer Aided Design (CAD) file using a 3D modeling program. In case of manufacturing duplicate fixture members of an existing fixture member, a 3D scanner may be used to create a 3D digital copy of the existing fixture member. Software modules, such as a slicer may be used to generate the output layer based on the digital model. The output layer may have a length and a width corresponding to the first length ‘L1’ and the first width ‘W1’ of the first layer 202 and/or the second length ‘L2’ and the second width ‘W2’ of the second layer 204.

At step 404, the output layer is communicated to a 3D printing machine. The software module may be coupled with the 3D printing machine to communicate the output layer with the 3D printing machine. Further, at step 406, the first layer 202 of the fixture member 106 is formed based at least in part on the output layer. The 3D printing machine may be configured to deposit a layer of material on a work surface based on the output layer received from the software module. In an example, the first layer 202 may be formed by laying down successive layers of material until the first thickness ‘T1’ is achieved. Each of the layers of material may be a thinly sliced horizontal cross-section of the first layer 202.

At step 408, the method 400 includes disposing the sensing device 206 on the first layer 202. In one example, the 3D printing machine may be controlled to dispose the sensing device 206 on the surface 210 of the first layer 202. In another example, the sensing device 206 may be manually disposed on the surface 210 of the first layer 202. The method 400 also includes disposing the insulation member 212 on the surface 210 of the first layer 202 in order to enclose the sensing device 206. In one example, the 3D printing machine may be controlled to dispose the insulation member 212 on the surface 210 of the first layer 202. In another example, the insulation member 212 may be manually disposed on the surface 210 of the first layer 202. The method 400 also includes defining the channel 214 on the surface 210 of the first layer 202. In one example, the channel 214 may be formed on the surface 210 using one or more operations, such as a milling, a grinding, or a combination thereof by an external machining tool after defining the first layer 202 by the 3D printing machine. In another example, the channel 214 may be defined during depositing of layers of material by the 3D printing machine.

At step 410, the method 400 includes forming the second layer 204 having the second thickness ‘T2’. The second layer 204 is formed based at least in part on the output layer. In an example, the second layer 204 may be formed by laying down successive layers of material until the second thickness ‘T2’ is achieved. Each of the layers of material may be a thinly sliced horizontal cross-section of the second layer 204. In one embodiment, the second layer 204 may be formed on the first layer 202 after disposing the sensing device 206 on the surface 210 of the first layer 202. The 3D printing machine may be controlled to deposit the material based on the output layer till the fixture member 106 is completely formed. In another embodiment, the second layer 204 may be formed separately and coupled to the first layer 202 to form the fixture member 106. In one embodiment, the second layer 204 may be welded to the first layer 202 for forming the fixture member 106. In another embodiment, the second layer 204 may be fastened to the first layer 202. In yet another embodiment, the second layer 204 may be attached to the first layer 202 using an adhesive.

With the 3D printing process for forming the first layer 202 and the second layer 204 of the fixture member 106, the complexity and cost associated with the manufacturing of the fixture member 106 may be minimized. Further, the fixture members with different geometries and dimensions may be easily made based on the application of the fixture member 106. Moreover, the manufacturing of the fixture member 106 with the 3D printing process require less time compare to existing method of manufacturing the fixture members. Thus, the fixture member 106 of the present disclosure may be manufactured in a convenient, cost-effective, and a time-saving manner.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fixture member in contact with a work piece to detect a load caused by the work piece, the fixture member comprising:
a first layer defining a first thickness and in contact with a base of a manufacturing center;
a second layer defining a second thickness, the second layer disposed on the first layer and in contact with the work piece;
wherein the work piece is positioned on the manufacturing center for having a manufacturing operation performed thereon; and
a sensing device disposed between the first layer and the second layer, the sensing device configured to generate a signal indicative of the load caused by the work piece, the load being indicative of positioning of the work piece relative to the manufacturing center.

2. The fixture member of claim 1 comprising an insulation member defined between the first layer and the second layer to enclose the sensing device therein.

3. The fixture member of claim 1, wherein the first layer comprises a surface configured to receive the sensing device thereon, and wherein the second layer is disposed on the surface of the first layer.

4. The fixture member of claim 3 comprising a channel defined on the surface of the first layer to receive an electric lead of the sensing device, wherein the electric lead is configured to communicate with a controller.

5. The fixture member of claim 1, wherein the first layer and the second layer are manufactured using a 3D printing process.

6. The fixture member of claim 1, wherein the second layer is welded to the first layer.

7. The fixture member of claim 1, wherein the second layer is fastened to the first layer.

8. The fixture member of claim 1, wherein the second layer is attached to the first layer by an adhesive.

9. The fixture member of claim 1, wherein the sensing device is a strain gauge.

10. A system comprising:
a work piece causing a load;
a fixture member comprising:
a first layer defining a first thickness and in contact with a base of a manufacturing center;
a second layer defining a second thickness, the second layer disposed on the first layer and in contact with the work piece
wherein the work piece is positioned on the manufacturing center for having a manufacturing operation performed thereon; and
a sensing device disposed between the first layer and the second layer, the sensing device configured to generate a signal indicative of the load caused by the work piece; and
a controller in communication with the sensing device, the controller configured to determine the load based on the signal received from the sensing device;
the load being indicative of positioning of the work piece relative to the manufacturing center.

11. The system of claim 10, wherein the fixture member comprises an insulation member defined between the first layer and the second layer to enclose the sensing device therein.

12. The system of claim 10, wherein the first layer comprises a surface configured to receive the sensing device thereon, and wherein the second layer is disposed on the surface of the first member.

13. The system of claim 12, wherein the fixture member comprises a channel defined on the surface of the first layer to receive an electric lead of the sensing device, wherein the electric lead is configured to communicate with the controller.

14. The system of claim 10, wherein the first layer and the second layer are manufactured using a 3D printing process.

15.-20. (canceled)
